(19) United States
(12) Patent Application Publication
(10) Pub. No.: US 2018/0210459 A1
(43) Pub. Date: Jul. 26, 2018

(54) TRAFFIC MANAGEMENT METHOD FOR MOBILE ROBOTICS SYSTEM

(71) Applicant: Zhejiang Guozi Robot Technology Co., Ltd., Hangzhou (CN)

(72) Inventors: Lei WEI, Hangzhou (CN); Yikun TAO, Hangzhou (CN); Lingfen ZHU, Hangzhou (CN); Xinfeng DU, Hangzhou (CN); Xia WANG, Hangzhou (CN); Hongbo ZHENG, Hangzhou (CN); Jizhong SHEN, Hangzhou (CN); Xudong MI, Hangzhou (CN)

(21) Appl. No.: 15/305,422

(22) PCT Filed: Oct. 8, 2016
(86) PCT No.: PCT/CN2016/101492

§ 371 Date: Oct. 20, 2016

(51) Int. Cl. G05D 1/02

(52) U.S. Cl. CPC G05D 1/0289; G05D 2201/0216; G05D 1/0212

(57) ABSTRACT

The present invention provides a traffic management method for a mobile robotics system, including: step 1, defining the physical size of a mobile robot and the position of a point on a traveling path; step 2, for each point on the traveling path, obtaining profile information of the mobile robot on this point in combination with the physical size of the mobile robot, so as to further obtain the profile information of the mobile robots over the whole traveling path; step 3, with respect to a first path, calculating whether the profiles of the mobile robots on the first path and on a second path intersect, and if the profiles thereof intersect, then the first path and the second path are disjoint; step 4, calculating whether the profiles of the mobile robots on the first path and all other paths intersect, so as to further obtain the disjoint sets of all paths. The method of the present invention realizes full automation of the disjoint sets among the paths, avoids dead locks as a result of the configuration as much as possible, and solves the problems of error-prone disjoint sets and heavy workload in the manual configuration.

### FIELD OF THE INVENTION

The present invention relates to a method for transporting inventory items in an inventory system and, more particularly, to a traffic management method for mobile robotics system.

### DESCRIPTION OF THE PRIOR ART

In modern inventory systems, such as an e-commerce warehouse, there is an extremely high requirement for rapid and accurate sorting of inventory items during order fulfillment. With developments in recent years, the speed, efficiency and degree of automation in storage and retrieve of inventory items have been greatly improved by relevant technologies such as sorting of item storages by mobile robots. The efficiency of the whole inventory system is directly affected by the operating efficiency of mobile robots with huge amounts of data in an inventory environment, and the traffic management system in the inventory system controls the movements of all mobile robots, of which the efficiency has a direct influence on the time required by the mobile robot to fulfill a transportation task.

A plurality of mobile robots walk on their respective paths and independently perform their tasks. An individual mobile robot cannot perceive a position or an operating state of other mobile robots. The important problem to be solved in the traffic management system is how to avoid collisions among the mobile robots while ensuring highly efficient logistics.

The prior traffic management method is usually a resource allocating method, in which the path and nodes of the path are taken as a resource, and whether the mobile robot can move onto this path is decided according to an application of the mobile robot, that is, only one mobile robot is allowed to go through one path. However, the mobile robot is not a mass point, but has a certain physical size, so a disjoint relationship exists between paths, which are utilized by the traffic management system to accept or refuse the application. However, the prior disjoint sets among the paths are mostly configured in a full-manual or half-manual manner, with great configuration difficulty and heavy workload. In addition, a dead lock is prone to occur as a result of the configuration, and it is difficult to find the error in the configuration.

### SUMMARY OF THE INVENTION

In view of the above defects in the prior art, the technical problem to be solved by the present invention is to provide a traffic management method for a mobile robotics system which is capable of realizing full automation of disjoint sets among paths and avoiding the dead lock as a result of the configuration as much as possible.

The present invention provides a traffic management method for a mobile robotics system, including the following steps:

step 1, defining the physical size of a mobile robot and the position of a point on a traveling path;

step 2, for each point on the traveling path, obtaining profile information of the mobile robot on this point on the traveling path in combination with the physical size of the mobile robot, so as to further obtain the profile information of the mobile robots over the whole traveling path;

step 3, with respect to a first path, calculating whether the profiles of the mobile robots on the first path and on a second path intersect, and if the profiles thereof intersect, then the first path and the second path are disjoint;

step 4, calculating whether the profiles of the mobile robots on the first path and all other paths intersect, so as to further obtain the disjoint sets of all paths.

Further, the travelling paths consist of a series of points.

Further, the traffic management method accepts or refuses the path based on the disjoint relationship among the paths.

Further, the traffic management method further includes a step 5: traversing all the traveling paths, with respect to two traveling paths thereof, to detect whether there is a possibility of the dead lock by using the existing path disjoint sets; if the dead lock possibility exists, then generating a new path disjoint set.

Further, the traffic management method further includes a step 6: using the latest disjoint set to recalculate whether there is a possibility of the dead lock, until there is no possibility of the dead lock, so as to further obtain complete disjoint sets.

Further, the traffic management method further includes a step 7: avoiding collisions and dead locks among the mobile robots according to the complete disjoint sets.

The traffic management method for the mobile robotics system of the present invention realizes full automation of the disjoint sets among the paths, has low requirements for configuration personnels, avoids dead locks as the result of the configuration as much as possible, and make it easy to find the configuration error. The traffic management method for the mobile robotics system of the present invention does not need to manually configure the disjoint sets to avoid dead lock, which solves the problems of error-prone disjoint sets and heavy workload in the manual configuration.

The conception, specific structures and technical effects of the present invention will be further illustrated below in conjunction with the accompanying drawings, in order to fully understand the objects, features and effects of the present invention.

### BRIEF DESCRIPTION OF THE DRAWINGS

FIG. 1 is a schematic diagram of the traveling path of the mobile robot as a mass point;

FIG. 2 is a schematic diagram showing the traveling paths of disjoint paths;

FIG. 3 is a schematic diagram showing the traveling paths in a dead lock situation.

### DETAILED DESCRIPTION OF THE PREFERRED EMBODIMENTS

A plurality of mobile robots walk in their respective paths and independently perform their tasks. An individual mobile robot cannot perceive positions or operating states of other mobile robots. The important problem to be solved in the traffic management system is how to avoid collisions among mobile robots while ensuring highly efficient logistics.

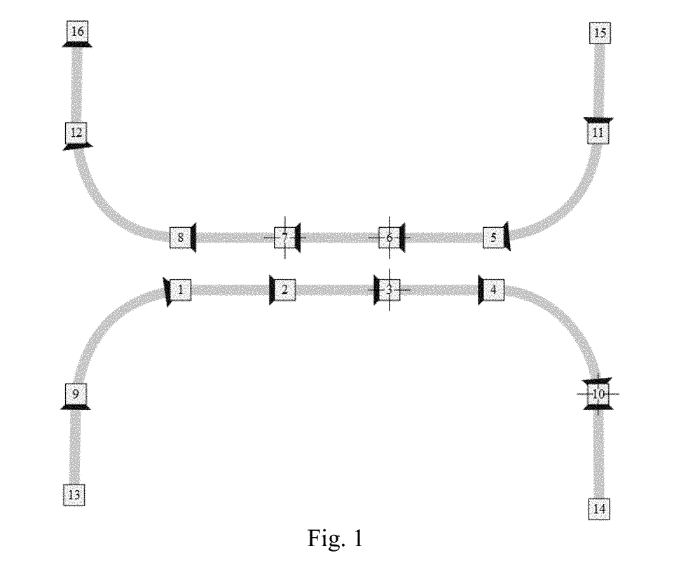

The mobile robot A moves from 1→2→3→4, and the mobile robot B moves from 5→6→7→8. The traffic management is not performed on the mobile robot A and the mobile robot B as shown in FIG. 1, without taking account of the sizes of the mobile robots, that is, the mobile robot is taken as a mass point.

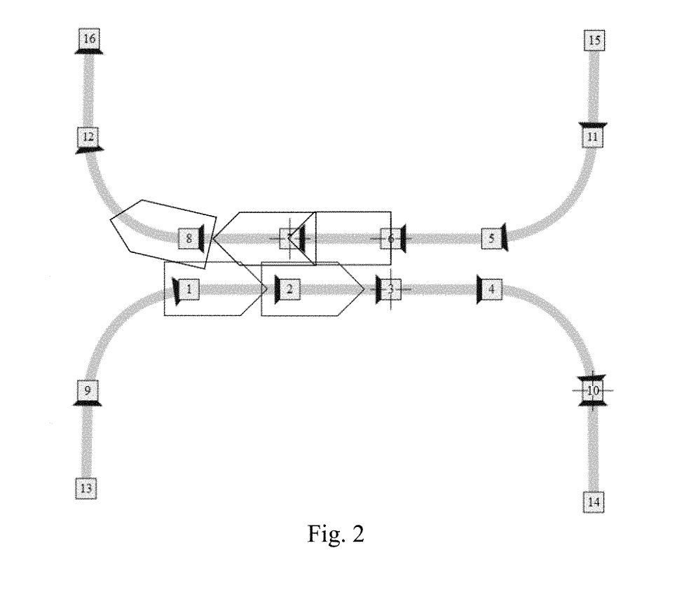

However, it is impossible not to take account of the physical size of the mobile robot, so the management needs to be performed in this case. The traffic management is to accept or refuse the path based on the disjoint relationship among the paths. As shown in FIG. 2, the path 1→2 and the paths 6→7, 7→8 and 8→9 are disjoint. In other words, when the mobile robot A requests to go through the path 1→2, the traffic management needs to check whether the paths 6→7, 7→8 and 8→9 have been occupied by other mobile robots or not. If the paths 6→7, 7→8 and 8→9 have been occupied by other mobile robots, the traffic management system refuses the request from the mobile robot A, and at this point, the mobile robot A has nothing to do but to wait until after the other mobile robots leave the paths 6→7, 7 8 and 8 9, and the traffic management system accepts the request from the mobile robot A, then the mobile robot A can go through 1→2. The disjoint set of edges is a basis of the traffic management, and can be configured in a manual manner, but is error-prone or omission-prone. Additionally, there is a heavy workload for configuration among complicated paths.

Therefore, one preferable embodiment of the present invention provides a traffic management method for a mobile robotics system, including the following steps:

step 1, defining the physical size of a mobile robot and the position of a point on a traveling path, wherein the travelling paths consist of a series of points;

step 2, for each point on the traveling path, obtaining profile information of the mobile robot on this point in combination with the physical size of the mobile robot, so as to further obtain the profile information of the mobile robots over the whole traveling path;

step 3, with respect to a first path, calculating whether the profiles of the mobile robots on the first path and on a second path intersect, and if the profiles thereof intersect, then the first path and the second path are disjoint;

step 4, calculating whether the profiles of the mobile robots on the first path and all other paths intersect, so as to further obtain the disjoint sets of all paths.

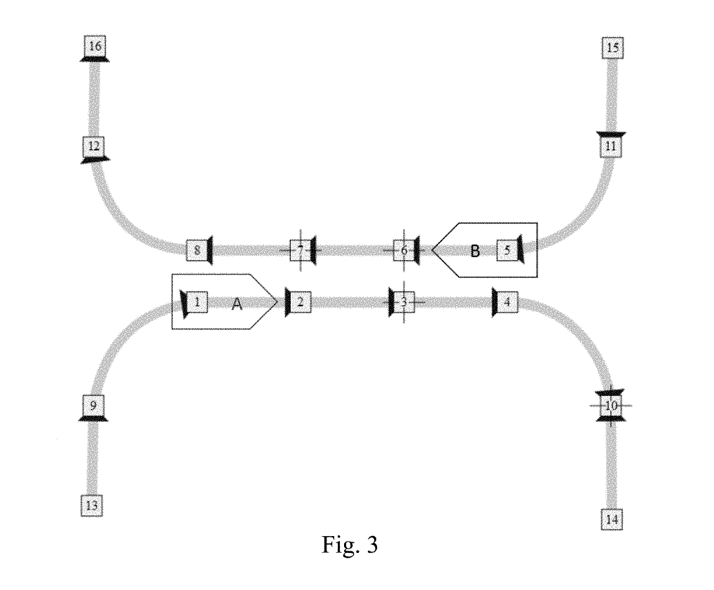

The disjoint sets of all the paths can be defined completely by the above method. In complex cases, by setting the path disjoint sets, it is possible to avoid collisions among mobile robots, but the dead lock may occur among the mobile robots. As shown in FIG. 3, when requesting the path 2→3, the mobile robot A has to stop at 1→2 since the mobile robot B is on the path 5→6, and the path 2→3 and the path 5→6 are disjoint. When requesting the path 6→7, the mobile robot B has to stop at 5→6 since the mobile robot A is on the path 1→2, and the path 1→2 and the path 6→7 are disjoint. Therefore, the mobile robot A waits for the mobile robot B to leave 5→6, and the mobile robot B waits for the mobile robot A to leave 1→2, and such situation is called the dead lock.

In light of the dead lock, the traffic management method of the preferable embodiment of the present invention further includes the following steps:

step 5, traversing all the traveling paths to detect, with respect to two traveling paths thereof, whether there is a possibility of the dead lock by using the existing path disjoint sets; if the dead lock possibility exists, then generating a new path disjoint set; in FIG. 3, the new path 1→2 and the path 5→6 are disjoint;

step 6, using the latest disjoint sets to recalculate whether there is a possibility of the dead lock, until there is no possibility of the dead lock, so as to further obtain complete disjoint sets;

step 7, avoiding collision and dead locks among the mobile robots according to the complete disjoint sets.

The traffic management method of the present embodiment can realize automatic configuration of the disjoint sets, does not need to manually configure the disjoint sets to avoid dead locks, and solves the problems of error-prone disjoint sets and heavy workload in the manual configuration.

The preferred specific embodiment of the invention has been described in detail above. It is to be understood that numerous modifications and variations can be made by those ordinary skilled in the art in accordance with the concepts of the present invention without any inventive effort. Therefore, the technical solutions that may be derived by those skilled in the art according to the concepts of the present invention on the basis of the prior art through logical analysis, reasoning and limited experiments should be within the scope of protection defined by the claims.

1. A traffic management method for a mobile robotics system, wherein the method comprising the following steps:
step 1, defining the physical size of a mobile robot and the position of a point on a traveling path;
step 2, for each point on the traveling path, obtaining profile information of the mobile robot on this point in combination with the physical size of the mobile robot, so as to further obtain the profile information of the mobile robots over the whole traveling path;
step 3, with respect to a first path, calculating whether the profiles of the mobile robots on the first path and on a second path intersect, and if the profiles thereof intersect, then the first path and the second path are disjoint;
step 4, calculating whether the profiles of the mobile robots on the first path and all other paths intersect, so as to further obtain the disjoint sets of all paths.

2. The traffic management method for a mobile robotics system according to claim 1, wherein the travelling paths consist of a series of points.

3. The traffic management method for a mobile robotics system according to claim 1, wherein the traffic management method accepts or refuses the path based on the disjoint relationship among the paths.

4. The traffic management method for a mobile robotics system according to claim 1, wherein the traffic management method further comprises a step 5: traversing all the traveling paths to detect, with respect to two traveling paths thereof, whether there is a possibility of the dead lock by using the existing path disjoint sets; if the dead lock possibility exists, then generating a new path disjoint set.

5. The traffic management method for a mobile robotics system according to claim 1, wherein the traffic management method further comprises a step 6: using the latest disjoint set to recalculate whether there is a possibility of the dead lock, until there is no possibility of the dead lock, so as to further obtain complete disjoint sets.

6. The traffic management method for a mobile robotics system according to claim 1, wherein the traffic management method further comprises a step 7: avoiding collision and dead locks among the mobile robots according to the complete disjoint sets.
